(19) United States
(12) Patent Application Publication
(10) Pub. No.: US 2025/0348776 A1
(43) Pub. Date: Nov. 13, 2025

(54) METHOD FOR IMPROVING DIFFUSION MODELS WITH REPRESENTATION LEARNING

(71) Applicant: Robert Bosch GmbH, Stuttgart (DE)

(72) Inventors: Johannes Tobias MOHREN, Grevenbroich (DE); Kehao LI, San Jose, CA (US)

(21) Appl. No.: 18/657,240

(22) Filed: May 7, 2024

(51) Int. Cl. G06N 20/00

(52) U.S. Cl. CPC G06N 20/00

(57) ABSTRACT

A method of generating a predicted signal using a diffusion model includes receiving an input signal including time series data or image data at an encoder model that includes a plurality of intermediate layers and a final layer, generating, via execution of the encoder model, a semantic representation of the input signal that includes an output of at least one of the plurality of intermediate layers, receiving, at the diffusion model, the semantic representation of the input signal, and generating and outputting the predicted signal on the semantic representation of the input signal. Generating the predicted signal includes at least one of noising and denoising the input signal based on the semantic representation of the input signal, and the predicted signal includes a predicted value indicating the at least one of the time series data and the image data of the input signal.

### TECHNICAL FIELD

The present disclosure relates to artificial intelligence (AI) techniques for signal representation learning for content such as time series and other sensor data, images, video, sound, and text, and more particularly to AI techniques for generating content using diffusion models.

### BACKGROUND

Various systems are configured to perform tasks using machine learning (ML) or other artificial intelligence (AI) techniques. For example, systems configured to perform image recognition, object detection, and/or other automated tasks may implement AI techniques. As one example, image detection systems and methods use various detection models trained for object and feature detection.

Diffusion models are a type of generative model trained by adding or introducing noise, such as Gaussian noise, to input data (e.g., introducing noise to training data corresponding to an image or other content, which may be referred to “noising”). Diffusion models learn to recover the input data to generate content, such as an image, by reversing the noising process (e.g., by performing “de-noising”).

### SUMMARY

A method of generating a predicted signal using a diffusion model includes receiving an input signal including time series data or image data at an encoder model that includes a plurality of intermediate layers and a final layer, generating, via execution of the encoder model, a semantic representation of the input signal that includes an output of at least one of the plurality of intermediate layers, receiving, at the diffusion model, the semantic representation of the input signal, and generating and outputting the predicted signal on the semantic representation of the input signal. Generating the predicted signal includes at least one of noising and denoising the input signal based on the semantic representation of the input signal, and the predicted signal includes a predicted value indicating the at least one of the time series data and the image data of the input signal.

Other embodiments include systems, one or more processors or processing devices, or other circuitry configured to implement functions corresponding to the principles of the present disclosure.

### BRIEF DESCRIPTION OF THE DRAWINGS

FIG. 1 generally illustrates a system for training a machine learning model according to the principles of the present disclosure.

FIG. 2 generally illustrates a computer-implemented method for training and implementing a machine learning model according to the principles of the present disclosure.

FIG. 3A generally illustrates an audio data labeling system according to the principles of the present disclosure.

FIG. 3B generally illustrates a portion of a data capturing system according to the principles of the present disclosure.

FIG. 3C generally illustrates an alternative audio data labeling system, according to the principles of the present disclosure.

FIG. 4A is a functional block diagram of an example system including an encoder model and a diffusion model according to the principles of the present disclosure.

FIG. 4B illustrates an example implementation of the system of FIG. 4A.

FIG. 4C illustrates steps of an example method for implementing a diffusion model according to the principles of the present disclosure.

FIG. 5 illustrates a schematic diagram of an interaction between a computer-controlled machine and a control system according to the principles of the present disclosure.

FIG. 6 illustrates a schematic diagram of the control system of FIG. 5 configured to control a vehicle, which may be a partially autonomous vehicle, a fully autonomous vehicle, a partially autonomous robot, or a fully autonomous robot, according to the principles of the present disclosure.

FIG. 7 illustrates a schematic diagram of the control system of FIG. 5 configured to control a manufacturing machine, such as a punch cutter, a cutter or a gun drill, of a manufacturing system, such as part of a production line.

FIG. 8 illustrates a schematic diagram of the control system of FIG. 5 configured to control a power tool, such as a power drill or driver that has an at least partially autonomous mode.

FIG. 9 illustrates a schematic diagram of the control system of FIG. 5 configured to control an automated personal assistant.

FIG. 10 illustrates a schematic diagram of the control system of FIG. 5 configured to control a monitoring system, such as a control access system or a surveillance system.

FIG. 11 illustrates a schematic diagram of the control system of FIG. 5 configured to control an imaging system, for example an MRI apparatus, x-ray imaging apparatus or ultrasonic apparatus.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

Time series data corresponds to data collected over time (e.g., at regular intervals) and may be time-stamped or otherwise indexed by time. Time series data is common and thereby frequently found in many real-world use cases from multiple domains such as manufacturing, healthcare, finance, and transportation. Time series data may be used for tasks including, but not limited to, prediction tasks, classification tasks, and anomaly detection tasks.

Generation of synthetic data is an important topic for time series data since often time series data is imbalanced due to lack of availability of accessibility. Hence, generating synthetic data is one way to augment and thereby balance a data set. Further, the inherent complexity of time series data leads to challenges in analysis and synthesis of the data. Most conventional generative methods focus on either computer vision (CV) or natural language processing (NLP) and are therefore not generally applicable for other types of data (e.g., time series data) due to following challenges.

One challenge associated with time series data (e.g., multivariate time series data) is the long, multi-dimensional, and intricate temporal relationships of such data. These relationships are often interrelated and are subject to a significant amount of noise and missing data. Further, the irregular intervals at which time series data is sampled add another layer of complexity, making traditional generative models less effective. In some examples, generative adversarial networks (GANs) and variational autoencoders (VAEs) may be configured to implement time series data synthesis. However, GANs have inadequate architecture for generating long sequences typical in time series data. Conversely, data generated by VAEs may lack accuracy, especially in details.

Diffusion models are trained by adding noise to (e.g., noising) input data and then denoising the data to recover and generate content. As used herein, “content” may refer to original content corresponding to the input data (e.g., data representative of a captured image, video, sound, text, etc.) or synthesized content (e.g., a synthesized image, video, sound, text, etc.). For example, some computer vision tasks implement denoising to generate more accurate and semantically meaningful images by incorporating a learnable condition configured to capture the semantic essence of input data. However, since time series data is more random and complex than cross-sectional data, conventional denoising techniques are less effective for time series data.

In some examples, “content” may include images, which may correspond to captured images, synthesized images, or combinations thereof. Images may be represented by image data. In some contexts herein, the terms “image” and “image data” may be used interchangeably and may refer to actual pixel values, color channels, vectors, and/or binary data corresponding to visual content of an image. In an example, “image” and/or “image data” refer to a raw representation of an image, such as an array of numerical values representing pixel intensities, which in some examples may include preprocessed data that originated from an image sensor. Conversely, “metadata” or “image metadata” may refer to contextual or supplementary details about the image, such as image size, format, creation date, geolocation data, and the like. In various examples, an “image” and “image data” may, but do not necessarily, further include metadata.

Systems and methods according to the present disclosure implement diffusion models configured to operate in a multivariate time series domain (i.e., to process and generate content based on time series data). For example, an encoder model (e.g., a semantic encoder model) is trained using a learnable encoder condition configured specifically for multivariate time series data. Multiple intermediate outputs of the encoder model are aggregated. Since the intermediate outputs are at different time granularities, this process uses outputs of earlier layers and information of semantics at different granularities are aggregated. In examples, unique hints for specific denoising steps are provided to optimize the guidance of diffusion models during reconstruction (e.g., by conditioning the encoder model in a diffusion step, aggregating two or more outputs of the encoder model using a cross-attention layer, etc.).

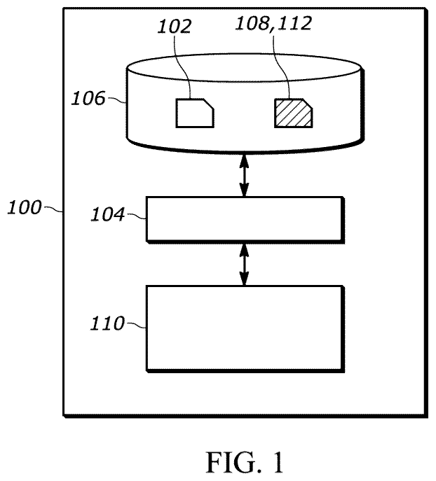

FIG. 1 shows one example system 100 for training of an ML or other AI model, such as a diffusion model (and/or an encoder model association with the diffusion model) according to the present disclosure. The system 100 may be configured to (and/or include circuitry configured to) implement the systems and methods of the present disclosure described below in more detail. The system 100 may comprise an input interface for accessing training data 102 for the diffusion model. For example, as illustrated in FIG. 1, the input interface may be constituted by a data storage interface 104 which may access the training data 102 from data storage 106. For example, the data storage interface 104 may be a memory interface or a persistent storage interface, e.g., a hard disk or an SSD interface, but also a personal, local or wide area network interface such as a Bluetooth, Zigbee or Wi-Fi interface or an ethernet or fiberoptic interface. The data storage 106 may be an internal data storage of the system 100, such as a hard drive or SSD, but also external data storage, e.g., network-accessible data storage.

In some embodiments, the data storage 106 may further comprise a data representation 108 of an untrained version of the diffusion model which may be accessed by the system 100 from the data storage 106. It will be appreciated, however, that the training data 102 and the data representation 108 of the untrained diffusion model may also each be accessed from different data storage, e.g., via a different subsystem of the data storage interface 104. Each subsystem may be of a type as is described above for the data storage interface 104.

In some embodiments, the data representation 108 of the untrained diffusion model may be internally generated by the system 100 on the basis of design parameters for the diffusion model, and therefore may not explicitly be stored on the data storage 106. The system 100 may further comprise a processor subsystem 110 which may be configured to, during operation of the system 100, provide an iterative function as a substitute for a stack of layers of the diffusion model to be trained. Here, respective layers of the stack of layers being substituted may have mutually shared weights and may receive, as input, an output of a previous layer, or for a first layer of the stack of layers, an initial activation, and a part of the input of the stack of layers.

The processor subsystem 110 may be further configured to iteratively train the diffusion model using the training data 102. Here, an iteration of the training by the processor subsystem 110 may comprise a forward propagation part and a backward propagation part. The processor subsystem 110 may be configured to perform the forward propagation part by, amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the diffusion model. The processor subsystem 110 is configured to train the diffusion model in accordance with systems and methods of the present disclosure as described below in more detail.

The system 100 may further comprise an output interface for outputting a data representation 112 of the trained diffusion model. This data may also be referred to as trained model data 112. For example, as also illustrated in FIG. 1, the output interface may be constituted by the data storage interface 104, with said interface being in these embodiments an input/output (‘IO’) interface, via which the trained model data 112 may be stored in the data storage 106. For example, the data representation 108 defining the ‘untrained’ diffusion model may, during or after the training, be replaced, at least in part by the data representation 112 of the trained diffusion model, in that the parameters of the diffusion model, such as weights, hyperparameters and other types of parameters of diffusion models, may be adapted to reflect the training on the training data 102. This is also illustrated in FIG. 1 by the reference numerals 108, 112 referring to the same data record on the data storage 106. In some embodiments, the data representation 112 may be stored separately from the data representation 108 defining the ‘untrained’ diffusion model. In some embodiments, the output interface may be separate from the data storage interface 104, but may in general be of a type as described above for the data storage interface 104.

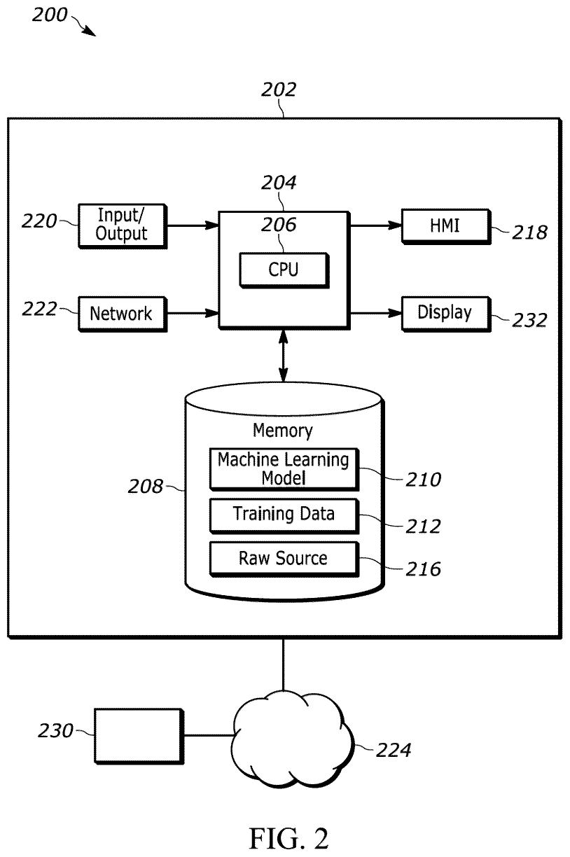

FIG. 2 depicts an example content generation system 200 configured to (and/or including circuitry configured to) implement a system for, annotating, augmenting, and/or generating data. In some examples, the content generation system 200 is configured to perform noising and/or denoising of input data to generate content. The content generation system 200 may include at least one computing system 202 configured to implement all or portions of the systems and methods of the present disclosure explained below in more detail. The computing system 202 may include at least one processor 204 that is operatively connected to a memory unit 208. The processor 204 may include one or more integrated circuits that implement the functionality of a central processing unit (CPU) 206. The CPU 206 may be a commercially available processing unit that implements an instruction set such as one of the x86, ARM, Power, or MIPS instruction set families. Various components of the system 200 may be implemented with same or different circuitry.

During operation, the CPU 206 may execute stored program instructions that are retrieved from the memory unit 208. The stored program instructions may include software that controls operation of the CPU 206 to perform the operation described herein. In some embodiments, the processor 204 may be a system on a chip (SoC) that integrates functionality of the CPU 206, the memory unit 208, a network interface, and input/output interfaces into a single integrated device. The computing system 202 may implement an operating system for managing various aspects of the operation.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store one or more machine learning models (e.g., represented in FIG. 2 as the machine learning model 210) or algorithms, a training dataset 212 for the machine learning model 210, raw source dataset 216, etc.

The computing system 202 may include a network interface device 222 that is configured to provide communication with external systems and devices. For example, the network interface device 222 may include a wired and/or wireless Ethernet interface as defined by Institute of Electrical and Electronics Engineers (IEEE) 802.11 family of standards. The network interface device 222 may include a cellular communication interface for communicating with a cellular network (e.g., 3G, 4G, 5G). The network interface device 222 may be further configured to provide a communication interface to an external network 224 or cloud.

The external network 224 may be referred to as the world-wide web or the Internet. The external network 224 may establish a standard communication protocol between computing devices. The external network 224 may allow information and data to be easily exchanged between computing devices and networks. One or more servers 230 may be in communication with the external network 224.

The computing system 202 may include an input/output (I/O) interface 220 that may be configured to provide digital and/or analog inputs and outputs. The I/O interface 220 may include additional serial interfaces for communicating with external devices (e.g., Universal Serial Bus (USB) interface).

The computing system 202 may include a human-machine interface (HMI) device 218 that may include any device that enables the system 200 to receive control input. Examples of input devices may include human interface inputs such as keyboards, mice, touchscreens, voice input devices, and other similar devices. The computing system 202 may include a display device 232. The computing system 202 may include hardware and software for outputting graphics and text information to the display device 232. The display device 232 may include an electronic display screen, projector, printer or other suitable device for displaying information to a user or operator. The computing system 202 may be further configured to allow interaction with remote HMI and remote display devices via the network interface device 222.

The system 200 may be implemented using one or multiple computing systems. While the example depicts a single computing system 202 that implements all of the described features, it is intended that various features and functions may be separated and implemented by multiple computing units in communication with one another. The particular system architecture selected may depend on a variety of factors.

The system 200 may implement the machine learning model 210 to analyze the raw source dataset 216. For example, the CPU 206 and/or other circuitry may implement the machine learning model 210. The raw source dataset 216 may include raw or unprocessed sensor data that may be representative of an input dataset for a machine learning system. The raw source dataset 216 may include images, video, video segments, audio, text-based information, and raw or partially processed sensor data (e.g., a radar map of objects). In some embodiments, the machine learning model 210 may include a deep-learning or neural network algorithm that is designed to perform a predetermined function. For example, the neural network algorithm may be configured to identify events or objects in images or video segments based on audio data.

The computer system 202 may store the training dataset 212 for the machine learning model 210. The training dataset 212 may represent a set of previously constructed data for training the machine learning model 210. The training dataset 212 may be used by the machine learning model 210 to learn various conditions and other factors (e.g., weighting factors) associated with an ML algorithm. The training dataset 212 may include a set of source data that has corresponding outcomes or results that the machine learning model 210 tries to duplicate via the learning process.

The machine learning model 210 may be operated in a learning mode using the training dataset 212 as input. The machine learning model 210 may be executed over a number of iterations using the data from the training dataset 212. With each iteration, the machine learning model 210 may update internal weighting factors based on the achieved results. For example, the machine learning model 210 can compare output results (e.g., generated content) with those included in the training dataset 212. Since the training dataset 212 includes the expected results, the machine learning model 210 can determine when performance is acceptable. After the machine learning model 210 achieves a predetermined performance level (e.g., 100% agreement with the outcomes associated with the training dataset 212), the machine learning model 210 may be executed using data that is not in the training dataset 212. The trained machine learning model 210 may be applied to new datasets to generate content. The machine learning model 210 may include a diffusion model trained in accordance with systems and methods of the present disclosure.

The machine learning model 210 may be configured to identify a particular feature in the raw source data 216. The raw source data 216 may include a plurality of instances or input dataset for which output results are desired (e.g., an image, a video stream or segment including audio data, etc.). For example only, the machine learning model 210 may be configured to identify objects or features in an image, objects or events in a video segment based on audio data, etc. In some examples, the machine learning model 210 may be configured to annotate identified objects, features, or events. The machine learning model 210 may be programmed to process the raw source data 216 to identify the presence of the particular features. The machine learning model 210 may be configured to identify a feature in the raw source data 216 as a predetermined feature. The raw source data 216 may be derived from a variety of sources. For example, the raw source data 216 may be actual input data collected by a machine learning system. The raw source data 216 may be machine generated for testing the system. As an example, the raw source data 216 may include raw image data, raw video and/or audio data from a camera, audio data from a microphone, etc.

In an example, the machine learning model 210 may process raw source data 216 and output video and/or audio data including one or more indications of an identified event. The machine learning model 210 may generate a confidence level or factor for each output generated. For example, a confidence value that exceeds a predetermined high-confidence threshold may indicate that the machine learning model 210 is confident that the identified event (or feature) corresponds to the particular event. A confidence value that is less than a low-confidence threshold may indicate that the machine learning model 210 has some uncertainty that the particular feature is present.

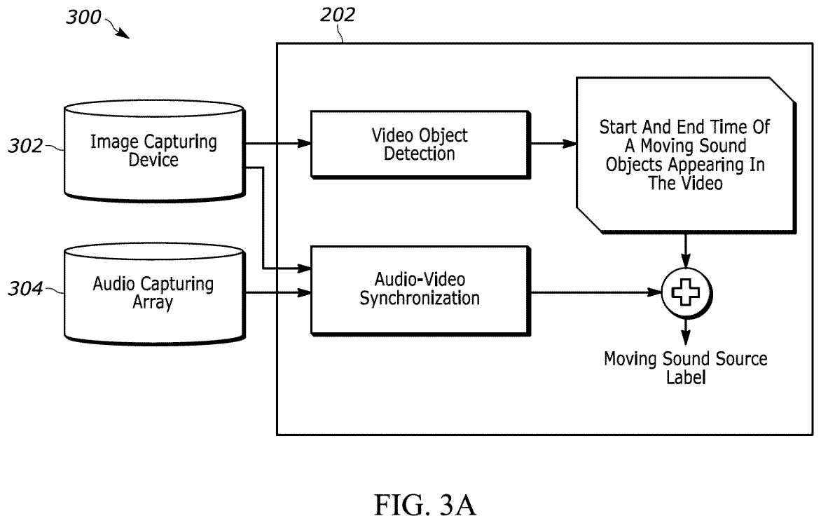

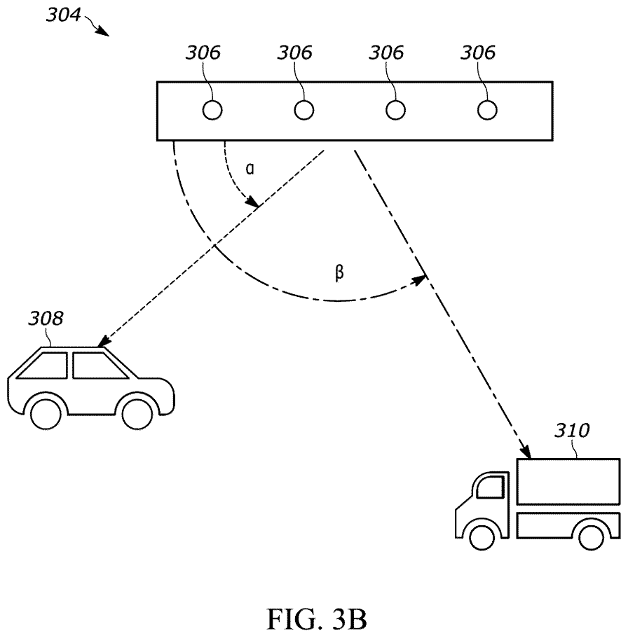

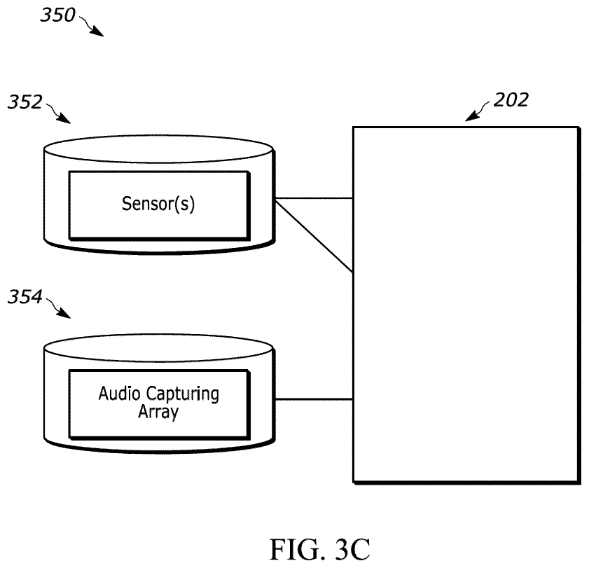

As is generally illustrated in FIGS. 3A and 3B, an example system 300 may include an image (e.g., image and/or video) capturing device 302, an audio capturing array 304, and the computing system 202. The system may receive, from the image capturing device 302, video stream data associated with a data capture environment. The system 202 may be configured to perform video object detection to identify one or more objects in corresponding images of the video stream data. The system 202 may receive, from the audio capturing array 304, audio stream data that corresponds to at least a portion of the video stream data. The audio capturing array 304 may include one or more microphones 306 or other suitable audio capturing devices. The systems and methods described herein may be configured to label, using output from at least a first machine learning model (e.g., such as the machine learning model 210 or other suitable machine learning model configured to provide output including one or more object or event detection predictions), at least some objects of the video stream data and/or audio stream data.

The system 202 may calculate (e.g., using at least one probabilistic-based function or other suitable technique or function), based on at least one data capturing characteristic, at least one offset value for at least a portion of the audio stream data that corresponds to at least one labeled object of the video stream data. The system 202 may synchronize, using at least the at least one offset value, at least a portion of the video stream data with the portion of the audio stream data that corresponds to the at least one labeled object of the video stream data. The at least one data capturing characteristic may include one or more characteristics of the at least one image capturing device, one or more characteristics of the at least one audio capturing array, one or more characteristics corresponding to a location of the at least one image capturing device relative to the at least one audio capturing array, one or more characteristics corresponding to a movement of an object in the video stream data, one or more other suitable data capturing characteristics, or a combination thereof.

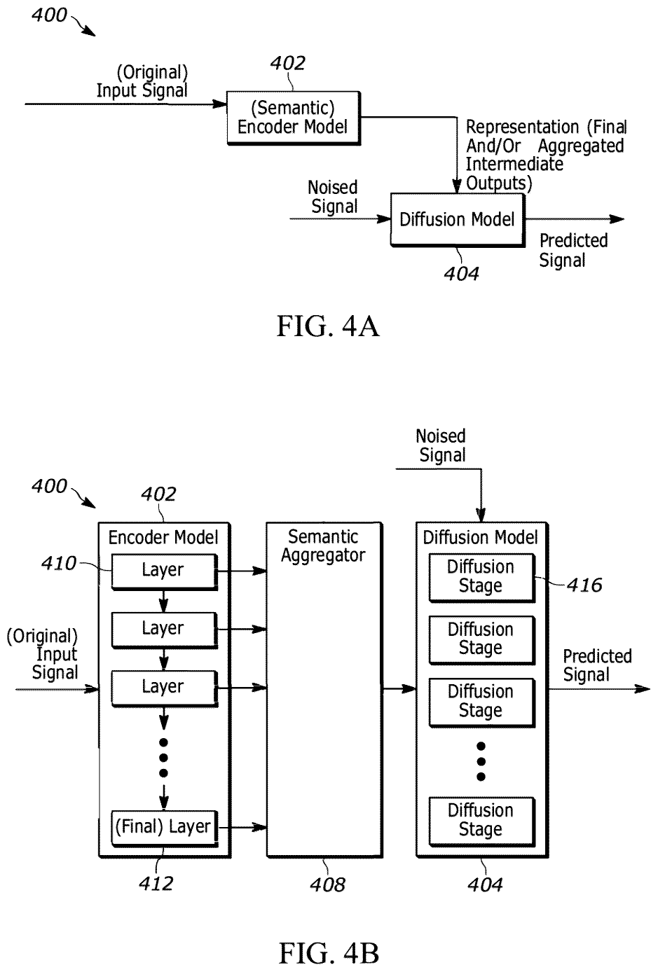

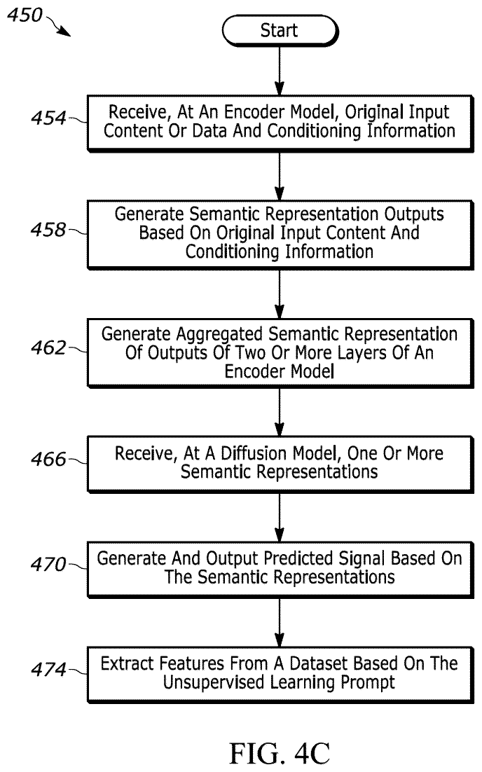

The system 202 may label, using one or more labels of the labeled objects of the video stream data and the at least one offset value, at least the portion of the audio stream data that corresponds to the at least one labeled object of the video stream data. Each respective label may include an event type, an event start indicator, and an event end indicator. The system 202 may generate training data using at least some of the labeled portion of the audio stream data. The system 202 may train a second machine learning model using the training data. The system 202 may detect, using the second machine learning model, one or more sounds associated with audio data provided as input to the second machine learning model. The second machine learning model may include any suitable machine learning model and may be configured to perform any suitable function, such as those described herein with respect to FIGS. 4-11.

In some embodiments, as is generally illustrated in FIG. 3C, the computing system 202 may be configured to label audio data based on sensor data received from one or more sensors, such as those described herein or any other suitable sensor or combination of sensors. The system 202 may receive, from the audio capturing array 354 or any suitable audio capturing device, such as one or more of the microphones 306 or other suitable audio capturing device, audio stream data associated with a data capture environment. It should be understood that the audio capturing array 354 may include features similar to those of the audio capturing array 304 and may include any suitable number of audio capturing devices. The system 202 may receive, from at least one sensor (e.g., such as the sensor 352) that is asynchronous relative to the audio capturing array 354, sensor data associated with the data capture environment. The sensor 354 may include at least one of an induction coil, a radar sensor, a LiDAR sensor, a sonar sensor, an image capturing device, any other suitable sensor, or a combination thereof. The audio capturing array 354 may be remotely located from the sensor 354, proximately located to the sensor 354, or located in any suitable relationship to the sensor 354.

The system 202 may identify, using output from at least a first machine learning model, such as the machine learning model 210 or other suitable machine learning model, at least some events in the sensor data. The machine learning model 210 may be configured to provide output including one or more event detection predictions based on the sensor data. The system 202 may synchronize at least a portion of the sensor data associated with the portion of the audio stream data that corresponds to the at least one event of the sensor data. The system 202 may label, using one or more labels extracted for respective events of the sensor data value, at least the portion of the audio stream data that corresponds to the at least one event of the sensor data. Each respective label may include an event type, an event start indicator, and an event end indicator. The system 202 may generate training data using at least some of the labeled portion of the audio stream data. The system 202 may train a second machine learning model using the training data. The system 202 may detect, using the second machine learning model, one or more sounds associated with audio data provided as input to the second machine learning model. The second machine learning model may include any suitable machine learning model and may be configured to perform any suitable function, such as those described herein with respect to FIGS. 4-11.

The systems and methods of the present disclosure (e.g., any of the systems 100, 200, etc.) are configured to implement diffusion models that operate in a multivariate time series domain as described below in more detail. The described systems and methods improve diffusion model architectures that use one or more additional learnable conditions for guiding the denoising process. For example, diffusion models may use either a deterministic or a learnable condition by training an encoder model in parallel (i.e., in parallel with the diffusion model) and providing an output of the encoder model as an input to the diffusion model. However, determining a level of detail to include in hints to the diffusion model can be a challenge as it is desirable to maintain semantic meaning but also to include some stochastic variation. In other words, simply duplicating and providing the original data as a hint to the diffusion module is less effective for training purposes.

As one example, during the denoising process, diffusion models may first add high-level features to the data and then gradually insert additional details (e.g., edges, a general shape, etc.) fine-tuning details, and so on. Accordingly, reconstruction objectives may change during progression through the various steps of the diffusion process. In some examples, systems and methods of the present disclosure are configured to provide the diffusion model with different hints (e.g., from different, intermediate layers of the encoder model) for specific diffusion steps. In this manner, the provided hints are relevant for a current level of progress through the denoising process and optimally guide the diffusion model.

For example, an encoder model (e.g., a learnable encoder) is configured to receive input data or content and generate and output (e.g., from a final layer of the encoder model) a representation for conditioning the diffusion model. As used herein, a “representation” output by an encoder model refers to a compressed, simplified, or otherwise modified version of the input data. In an example where the input data (e.g., data corresponding to one or more input signals) includes time series data, the representation output by the encoder model may capture essential characteristics, patterns, context, and anomalies of the time series data. Conversely, in an example where the input data includes an image or image data, the representation output by the encoder model may include essential image features of the image.

In some examples of the present disclosure, outputs from intermediate (e.g., hidden) layers of the encoder model are provided to the diffusion model (i.e., in addition to the representation output from the final layer of the encoder model). In this manner, the encoder model provides information corresponding to features that are captured in earlier layers (which, for example, may include more local and low-frequency hints than the representation output from the final layer of the encoder model). In various example, outputs of only some or all of the intermediate layers can be provided to the diffusion model, and/or outputs of the one or more of the intermediate layers may be modified prior to being provided to the diffusion model (e.g., to allow some variance between the outputs of the intermediate layers and the inputs to the diffusion model).

In other examples of the present disclosure, the diffusion model may be provided with different hints dependent upon a particular denoising step of the diffusion model. In these examples, the encoder model may be conditioned on a particular diffusion step (e.g., by providing information corresponding to a particular diffusion step to the encoder model, such as an aggregated semantic representation of the encoder) and/or by implementing the diffusion step in a cross-attention layer (e.g., a semantic aggregator including a cross-attention layer) to aggregate multiple intermediate outputs of the encoder model.

Outputs of the diffusion model can be used for various downstream tasks, such as anomaly detection, classification, data augmentation etc.

FIG. 4A is a functional block diagram of an example system 400 including an encoder model 402 (e.g., a semantic encoder model) and a diffusion model 404 according to the principles of the present disclosure. For example, one or more computing devices, processors, or processing devices are configured to execute instructions to implement the system 400, such as one or more of the processors of the systems described herein.

The encoder model 400 is configured to receive input content or data (e.g., an input signal corresponding to original input data, such as time series data, image data, etc.) and generate a representation or representation output of the input data. Accordingly, the representation generated and output by the encoder model 400 to the diffusion model 404 is responsive to the current stage (e.g., a current diffusion stage) being executed or to be executed by the diffusion model 404. As used herein, a diffusion step or stage may include, but is not limited to, a noising or denoising stage of the diffusion process. In some examples, the representation generated and output by the encoder model 400 includes only representation data output from a final layer of the encoder model 400. In other examples, the representation includes and/or is based on an aggregation of representation data output from at least one intermediate or hidden layer of the encoder model 402. As used herein, an intermediate layer may correspond to a processing or generative layer of the encoder model 402 other than a final layer of the encoder model 402.

The diffusion model 404 receives a noised signal (e.g., the input signal subsequent to one or more noising stages or steps) and the representation generated and output by the encoder model 400. In some examples, the representation received by the diffusion model 404 includes only the representation as generated and output by the final layer of the encoder model 402. In other examples, the representation received by the diffusion model 404 includes representation data output by at least one intermediate layer of the encoder model 402 (in addition to and/or instead of the representation data output by the final layer of the encoder model 402). In still other examples, the representation received by the diffusion model 402 includes an aggregate or otherwise modified representation of two or more layers of the encoder model 402 (e.g., two or more intermediate layers, the final layer and one or more of the intermediate layers, etc.). Accordingly, for a given diffusion stage of the diffusion model 404, the diffusion model 404 may receive a single or multiple outputs from the encoder model 402 in various examples. In this manner, the diffusion model 404 is configured to generate and output predictive content or data (e.g. a predicted signal) based on the noised signal and the representation generated and output by the encoder model 402.

FIG. 4B illustrates one example implementation of the system 400 in more detail. For example, one or more computing devices, processors, or processing devices are configured to execute instructions to implement the system 400, such as one or more of the processors of the systems described herein. In various examples, one or more of the components shown in FIG. 4B may be omitted. For example, as shown, the system 400 includes the encoder model 402, the diffusion model 404, and a semantic aggregator 408.

As shown, the encoder model 402 includes a plurality of layers, including one or more intermediate layers 410 and a final layer 412. Typically, the layers are continuous or sequential (i.e., the output of a previous layer is the input to a subsequent layer). The intermediate layers 410 are configured to generate representation data corresponding to different features or levels of features of the input data, building upon extraction of features performed by previous layers. For example, initial layers of the encoder model 402 may be configured to detect and identify low-level (e.g., less complex) local features while subsequent layers are configured to iteratively integrate features detected by previous layers through a hierarchical process that progressively abstracts and combines the features into coherent high-level global features. For example, for an encoder model configured to process an image, one or more initial layers (e.g. of the intermediate layers 410) may be configured to detect low-level features such as edges, an overall shape, colors etc. One or more middle layers may be configured to begin combining low-level features to identify shapes, textures, patterns, etc. One or more later layers (including, for example, the final layer 412) may be configured to integrate the previously detected features to identify more complex features and objects, parts of objects, spatial relationships between objects, etc.

In some examples of the encoder module 402 of the present disclosure, outputs from one or more of the intermediate layers 410 are provided to the diffusion model 404 as described above. In this manner, the encoder model 402 provides information (e.g., representation data, hints, etc.) corresponding to features that are detected in the intermediate layers 410. The use of outputs of one or more of the intermediate layers provides information corresponding to features that are detected earlier in the encoding process (i.e., relative to the output of the final layer 412) and therefore contain more low-level and local information of the input data as compared to the output of the final layer 412. Accordingly, the diffusion model 404 is configured to perform the diffusion process and generate the predicted signal using information corresponding to local and low-frequency features identified by the encoder model 402.

In some examples, the outputs of one or more of the intermediate layers 410 and the final layer 412 are provided to the semantic aggregator 408, which in turn provides an aggregated output to the diffusion model 404. For example, the output of the semantic aggregator may include a semantic representation of outputs of the one or more of the intermediate layers 410 and the final layer 412. In other examples, outputs of one or more of intermediate layers 410 and the final layer 412 may be provided directly to the diffusion model 404.

As an example, the diffusion model 404 includes multiple diffusion steps or stages 416, where each of the stages 416 is responsive to an output of a previous stage. Each of the stages 416 may correspond to a noising stage or a denoising stage. For example, to perform noising, noise (e.g., as sampled from Gaussian noise) is added in one or more noising stages such that each stage is noisier than a previous stage. The magnitude of noise added in each stage may vary. Conversely, to perform denoising at a given current stage, the diffusion model 404 predicts an amount of noise added to the signal (e.g., based on the received noised signal and the current stage). In this manner, the diffusion model 404 is trained to differentiate between an original signal and noise to generate a predicted signal corresponding to the original input signal provided to the encoder model 402. The diffusion model 404 according to the present disclosure is configured to generate the predicted signal further based on outputs of one or more of the intermediate layers 410 of the encoder model 402.

The diffusion model 404 may implement a noise prediction process (e.g., a noise prediction process using dilated convolution). For example, the noise prediction process may be performed for each of the stages 416 of the diffusion model 404. In one example, during training, original signals x₀ are sampled and then encoded as zₛₑₘ=Enc(x₀). A diffusion step t is uniformly sampled and noise ϵ is sampled from a Gaussian distribution. A parameterized noise predictor ϵθ then attempts to predict the added noise given the noisy signal xₜ, a representation of the encoded signal zₛₑₘ, and a diffusion step t. The noisy signal xₜ is derived and parameters are iteratively updated until the convergence is reached.

In an example, the noise prediction process includes N residual blocks that are organized into m groups having n=N/m residual blocks each. Within each of the m groups, dilation increases exponentially, following a pattern [1, 2, 4, . . . , 2(n−1)]. An embedded diffusion step ψ(t) and an encoded representation zₛₑₘ are transformed by linear layers to match a particular dimension and then injected into each residual block by means of shift and scale. Ultimately, an output projection predicts the noise given at diffusion step t. An example training algorithm is shown below:

Algorithm 1 Training

| | |
|---|---|
| 1: | repeat |
| 2: | Sample: x₀ |
| 3: | zₛₑₘ = Enc(x₀) |
| 4: | t ~ Uniform(1,..., T) |
| 5: | ε ~ N(0, 1) |
| 6: | Δ_{θ} \|\| ε − ε_{θ} (\sqrt{α̅ₜ}x₀ + \sqrt{1 − α̅ₜ}ε, zₛₑₘ, t)\|\|² |
| 7: | until converged |

In some examples, the diffusion model 404 is provided with different hints dependent upon a particular one of the denoising stages 416 being executed. For example, during denoising, the general goal is to gradually decrease the level of noise while increasing the level of the signal represented by the data. Given almost completely noisy data (e.g., the noised signal shown in FIGS. 4A and 4B), the diffusion model 404 begins by reconstructing high-level features (e.g., a mean of the data) and then proceeds to identify and construct more complex features (e.g., shapes, features, etc.) prior to adding fine details to the signal. To guide this denoising process more effectively in accordance with the present disclosure, specific hints are provided to the diffusion model 404 (e.g., directly from the encoder model 402, from the semantic aggregator 408, etc.) dependent upon the current denoising step. These hints are configured to be consistent with the current level of detail that is being added at a current denoising step or stage, ultimately providing an improved guiding process during denoising and enabling more accurate and meaningful reconstruction by capturing a more significant representation for a particular stage.

As one example, the encoder model 402 receives the original data and provides an output (e.g., a semantic representation zₛₑₘ) to the diffusion model accordingly. The output may include, but is not limited to, an indicator of a stage t of the diffusion model 404. For example, for an original input signal x, and a given stage t of the diffusion model 404, the output of the encoder model 402 (or, in some examples, of the semantic aggregator 408) may be defined as zₛₑₘ=Enc(x₀,t). Accordingly, the output of the encoder model 402 may vary based on which diffusion stage is being executed/performed. In this manner, the diffusion model 404 receives, from the encoder model 402, a semantic representation or aggregation specific to the given stage t of the diffusion model 404.

In other examples, the semantic aggregator 408 is implemented as a cross-attention layer configured to provide specific intermediate outputs of the encoder model 402. For example, during training (e.g., of the encoder model 402, the diffusion model 404, and/or the aggregator 408), the system 400 learns which intermediate outputs have the most significance to respective stages of the diffusion model 404 to facilitate accurate reconstruction of the input data. For example, one or more of the intermediate outputs (i.e., the outputs of the intermediate layers 410) are concatenated and provided to the aggregator 408. The aggregator 408 may be configured to weight the different intermediate outputs depending on the current diffusion stage. In other words, for respective stages of the diffusion model 404, the intermediate outputs may be assigned different weights (“attention weights”). In one example, the aggregator 408 applies a compatibility function (e.g., a dot product function) that assesses the relevance of each key K to each query Q as follows:

$$Q = diffusion step t * {W}_{q} \\ K = intermediate outputs * {W}_{k} \\ V = intermediate outputs * {W}_{v} \\ Attention ( Q , K , V ) = softmax ( \frac{Q {K}^{T}}{\sqrt{{d}_{k}}} ) V$$

The dot product is subsequently normalized to form a probability distribution, which may be executed via a softmax function as shown, ensuring that the scores cumulatively amount to one to enable the interpretation of the scores as weights. In this example, dk represents the dimensionality of the keys used for scaling the dot product, which prevents the magnitudes of dot products from becoming excessively large, which could lead to vanishing gradients during training. The attention mechanism weights the elements of the value vector V, enabling the model to “attend” selectively to specific portions of the intermediate outputs relevant to a given task (e.g., a given stage of the diffusion model 404).

The encoder model 402 may implement down-sample patching and attention processes or steps prior to providing the outputs of the intermediate layers 410 to the semantic aggregator 408. The down-sample patching process includes down-sampling (e.g., on an original multivariate time series) to mitigate noise while capturing essential features. In an example, down-sampling includes N down-sample patching steps or blocks. Each down sample patching block includes n residual blocks incorporating group normalization, a Silu activation function, and a one-dimensional dilated convolution layer. Following the down-sample patching process, the original input multivariate time series is transformed into a down-sampled time series.

As one example, at the end of each layer of the encoder model 402, a down-sample is performed, causing the next layer to extract higher-order features. For example, an input of a first layer may have a length of 96 and a dimension of 6. With down-sampling, the output of the first layer (and an input of a second, subsequent layer) has a length of 48 and a dimension of 128. This change from 96 to 48 causes semantics to be captured at a different granularity. Conversely, the dimension of 128 indicates higher-order features relative to the dimension of 6.

Conversely, the down-sample attention process includes applying positional embedding to the down-sampled time series, followed by N down sample attention steps or blocks. In each down sample attention step, n multiple multi-head attention groups are used to capture semantics at different levels. Each attention group includes a multi-head attention layer and a multi-layer perceptron (MLP) layer of one-dimensional convolution. Additionally, to capture semantics at varying granularity, down-sampling is applied after the multi-head attention groups (e.g., using either average pooling or one-dimensional convolution.

In some examples the semantic aggregator 408 may be configured to implement adaptive average pooling to the intermediate semantics of each multi-head attention group (e.g., outputs corresponding to the semantic representations output by each of the intermediate layers 410), resulting in a down-sampled sequence length las. The channel size of each attention layer may remain unchanged, denoted as dₛₑₘ. Therefore, each multi-head attention group generates a semantic representation with the same length and dimension (dₛₑₘ, l_{ds}). Respective semantics of all multi-head attention groups are concatenated, leading to a dimension of (N×n, dₛₑₘ, l_{ds}). Subsequently, two-dimensional convolutions with a window size at (dₛₑₘ, l), an input channel at N×n, and an output channel at d_{agg} are applied to aggregate semantics at different granularity, changing the concatenated semantics from dimension (N×n, dₛₑₘ, l_{ds}) to dimension (d_{agg}, l, l_{ds}). The aggregated one-dimensional semantic representation may be obtained by further down-sampling the semantic in accordance with the dimension l_{ds}.

FIG. 4C illustrates steps of an example method 450 for implementing (e.g., training) a diffusion model according to the principles of the present disclosure. For example, one or more processors or processing devices are configured to execute instructions to implement the method 450, such as one or more of the processors of the systems described herein. The method 450 may correspond to performing inference tasks (in contrast to training, such as training performed by the training algorithm described above). Inference tasks may include, but are not limited to, encoding an input (e.g., to generate a vector representing the input); generating data similar to the input data (e.g., by providing, to the diffusion model, the semantic representation to be used for generating similar data; and sampling out of a representation space (e.g., interpolating) to control semantics in generated data.

At 454, the method 450 (e.g., an encoder model) receives an input signal corresponding to original input data (e.g., content such as time series data, an image or image data, etc.). As used herein, the term “original” may refer to raw or unmodified (e.g., not noised) data. In some examples, the method 450 further receives information identifying a particular diffusion model step or stage.

At 458, the method 450 (e.g., the encoder model) generates a plurality of semantic representation outputs based on the original input data. In some examples, the method 450 may be configured to provide only an output from a final layer of the encoder model. In other examples, the method 450 may be configured to provide at least one output from an intermediate layer of the encoder model.

At 462, the method 450 (e.g., at a cross-attention layer, semantic aggregator, etc.), in examples where the encoder model provides at least one output from an intermediate layer, generates an aggregated semantic representation of outputs of two or more layers of the encoder model. For example, the method 450 generates the aggregated semantic representation. The aggregated semantic representation may be based on a weighted sum, average, or other combination of the outputs from the two or more layers. For example, the outputs of the layers may be assigned respective weights based on a current stage of the diffusion model.

At 466 the method 450 (e.g., a diffusion model) receives one or more semantic representations (e.g., a semantic representation from the final layer of the encoder model, semantic representations from one or more intermediate layers of the encoder model, an aggregated semantic representation, etc.). At 470, the method 450 (e.g., the diffusion model), generates and outputs a predicted signal based on the semantic representations. For example, the predicted signal is generated by noising and denoising the data using hints (i.e., the semantic representations) received from the encoder model. In some examples, the hints are conditioned such that, at each stage of the diffusion process, the semantic representations are configured in accordance with the current stage of the diffusion process.

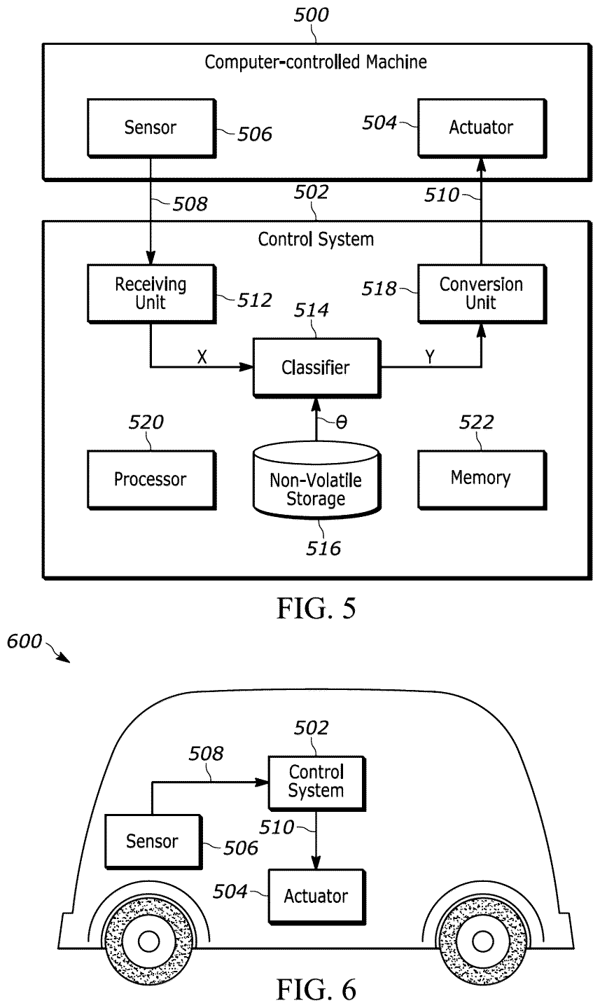

At 474, the method 450 includes performing at least one task using an output of the diffusion model. For example, subsequent to being trained using the encoder model, the diffusion model is configured to generate predicted content based on an original or noised signal. The output of the diffusion model can be used to perform any of the tasks described herein, such as tasks of the systems described below in FIGS. 5-11.

FIGS. 5-11 depict example systems and devices that may implement diffusion models according to the present disclosure. FIG. 5 depicts a schematic diagram of an interaction between a computer-controlled machine 500 and control system 502. In an example, the control system 502 is configured to control the computer-controlled machine 500 by executing a diffusion model in accordance with the principles of the present disclosure. Computer-controlled machine 500 includes actuator 504 and sensor 506. Actuator 504 may include one or more actuators and sensor 506 may include one or more sensors. Sensor 506 is configured to sense a condition of computer-controlled machine 500. Sensor 506 may be configured to encode the sensed condition into sensor signals 508 and to transmit sensor signals 508 to control system 502. Non-limiting examples of sensor 506 include video, radar, LiDAR, ultrasonic, and motion sensors. In some embodiments, sensor 506 is an optical sensor configured to sense optical images of an environment proximate to computer-controlled machine 500.

Control system 502 is configured to receive sensor signals 508 from computer-controlled machine 500. As set forth below, control system 502 may be further configured to compute actuator control commands 510 depending on the sensor signals and to transmit actuator control commands 510 to actuator 504 of computer-controlled machine 500.

As shown in FIG. 5, control system 502 includes receiving unit 512. Receiving unit 512 may be configured to receive sensor signals 508 from sensor 506 and to transform sensor signals 508 into input signals x. In an alternative embodiment, sensor signals 508 are received directly as input signals x without receiving unit 512. Each input signal x may be a portion of each sensor signal 508. Receiving unit 512 may be configured to process each sensor signal 508 to produce each input signal x. Input signal x may include data corresponding to an image recorded by sensor 506.

Control system 502 includes classifier 514. Classifier 514 may be configured to classify input signals x into one or more labels using a machine learning (ML) algorithm, such as a neural network. For example, the classifier 514 corresponds to the classifier 408 described above. Classifier 514 is configured to be parametrized by parameters, such as those described above (e.g., parameter θ). Parameters θ may be stored in and provided by non-volatile storage 516. Classifier 514 is configured to determine output signals y from input signals x. Each output signal y includes information that assigns one or more labels to each input signal x. Classifier 514 may transmit output signals y to conversion unit 518. Conversion unit 518 is configured to covert output signals y into actuator control commands 510. Control system 502 is configured to transmit actuator control commands 510 to actuator 504, which is configured to actuate computer-controlled machine 500 in response to actuator control commands 510. In some embodiments, actuator 504 is configured to actuate computer-controlled machine 500 based directly on output signals y.

Upon receipt of actuator control commands 510 by actuator 504, actuator 504 is configured to execute an action corresponding to the related actuator control command 510. Actuator 504 may include a control logic configured to transform actuator control commands 510 into a second actuator control command, which is utilized to control actuator 504. In one or more embodiments, actuator control commands 510 may be utilized to control a display instead of or in addition to an actuator.

In some embodiments, control system 502 includes sensor 506 instead of or in addition to computer-controlled machine 500 including sensor 506. Control system 502 may also include actuator 504 instead of or in addition to computer-controlled machine 500 including actuator 504.

As shown in FIG. 5, control system 502 also includes processor 520 and memory 522. Processor 520 may include one or more processors. Memory 522 may include one or more memory devices. The classifier 514 (e.g., ML algorithms) of one or more embodiments may be implemented by control system 502, which includes non-volatile storage 516, processor 520 and memory 522.

Non-volatile storage 516 may include one or more persistent data storage devices such as a hard drive, optical drive, tape drive, non-volatile solid-state device, cloud storage or any other device capable of persistently storing information. Processor 520 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 522. Memory 522 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information.

Processor 520 may be configured to read into memory 522 and execute computer-executable instructions residing in non-volatile storage 516 and embodying one or more anomaly detection methodologies of one or more embodiments. Non-volatile storage 516 may include one or more operating systems and applications. Non-volatile storage 516 may store compiled and/or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

Upon execution by processor 520, the computer-executable instructions of non-volatile storage 516 may cause control system 502 to implement one or more of the anomaly detection methodologies as disclosed herein. Non-volatile storage 516 may also include data supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

The processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

FIG. 6 depicts a schematic diagram of control system 502 configured to control vehicle 600, which may be an at least partially autonomous vehicle or an at least partially autonomous robot. In an example, the control system 502 is configured to control the vehicle 600 by executing a diffusion model in accordance with the principles of the present disclosure. Vehicle 600 includes actuator 504 and sensor 506. Sensor 506 may include one or more video sensors, cameras, radar sensors, ultrasonic sensors, LiDAR sensors, and/or position sensors (e.g. GPS). One or more of the one or more specific sensors may be integrated into vehicle 600. Alternatively or in addition to one or more specific sensors identified above, sensor 506 may include a software module configured to, upon execution, determine a state of actuator 504. One non-limiting example of a software module includes a weather information software module configured to determine a present or future state of the weather proximate vehicle 600 or other location.

Classifier 514 of control system 502 of vehicle 600 may be configured to detect objects in the vicinity of vehicle 600 dependent on input signals x. In such an embodiment, output signal y may include information characterizing the vicinity of objects to vehicle 600. Actuator control command 510 may be determined in accordance with this information. The actuator control command 510 may be used to avoid collisions with the detected objects.

In some embodiments, the vehicle 600 is an at least partially autonomous vehicle, actuator 504 may be embodied in a brake, a propulsion system, an engine, a drivetrain, or a steering of vehicle 600. Actuator control commands 510 may be determined such that actuator 504 is controlled such that vehicle 600 avoids collisions with detected objects. Detected objects may also be classified according to what classifier 514 deems them most likely to be, such as pedestrians or trees. The actuator control commands 510 may be determined depending on the classification. In a scenario where an adversarial attack may occur, the system described above may be further trained to better detect objects or identify a change in lighting conditions or an angle for a sensor or camera on vehicle 600.

In some embodiments where vehicle 600 is an at least partially autonomous robot, vehicle 600 may be a mobile robot that is configured to carry out one or more functions, such as flying, swimming, diving and stepping. The mobile robot may be an at least partially autonomous lawn mower or an at least partially autonomous cleaning robot. In such embodiments, the actuator control command 510 may be determined such that a propulsion unit, steering unit and/or brake unit of the mobile robot may be controlled such that the mobile robot may avoid collisions with identified objects.

In some embodiments, vehicle 600 is an at least partially autonomous robot in the form of a gardening robot. In such embodiment, vehicle 600 may use an optical sensor as sensor 506 to determine a state of plants in an environment proximate vehicle 600. Actuator 504 may be a nozzle configured to spray chemicals. Depending on an identified species and/or an identified state of the plants, actuator control command 510 may be determined to cause actuator 504 to spray the plants with a suitable quantity of suitable chemicals.

Vehicle 600 may be an at least partially autonomous robot in the form of a domestic appliance. Non-limiting examples of domestic appliances include a washing machine, a stove, an oven, a microwave, or a dishwasher. In such a vehicle 600, sensor 506 may be an optical sensor configured to detect a state of an object which is to undergo processing by the household appliance. For example, in the case of the domestic appliance being a washing machine, sensor 506 may detect a state of the laundry inside the washing machine. Actuator control command 510 may be determined based on the detected state of the laundry.

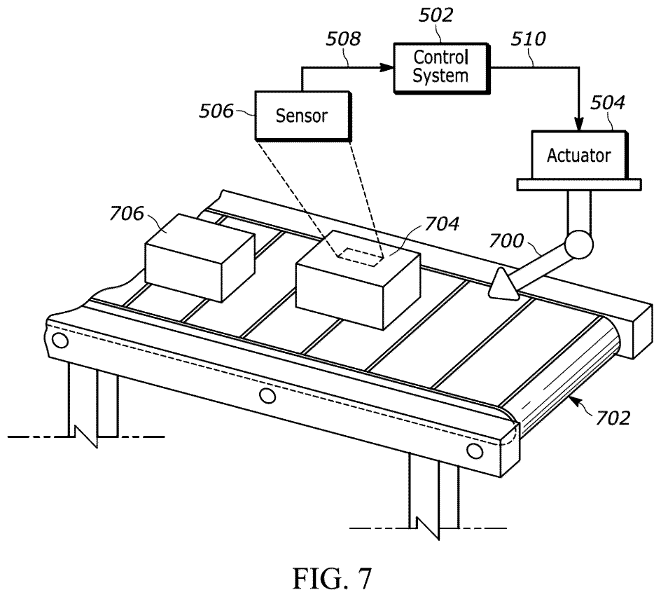

FIG. 7 depicts a schematic diagram of control system 502 configured to control system 700 (e.g., a manufacturing machine), such as a punch cutter, a cutter or a gun drill, of manufacturing system 702, such as part of a production line. Control system 502 may be configured to control actuator 504, which is configured to control system 700 (e.g., manufacturing machine). In an example, the control system 502 is configured to control the system 700 by executing a diffusion model in accordance with the principles of the present disclosure.

Sensor 506 of system 700 (e.g., manufacturing machine) may be an optical sensor configured to capture one or more properties of manufactured product 704. Classifier 514 may be configured to determine a state of manufactured product 704 from one or more of the captured properties. Actuator 504 may be configured to control system 700 (e.g., manufacturing machine) depending on the determined state of manufactured product 704 for a subsequent manufacturing step of manufactured product 704. The actuator 504 may be configured to control functions of system 700 (e.g., manufacturing machine) on subsequent manufactured product 706 of system 700 (e.g., manufacturing machine) depending on the determined state of manufactured product 704.

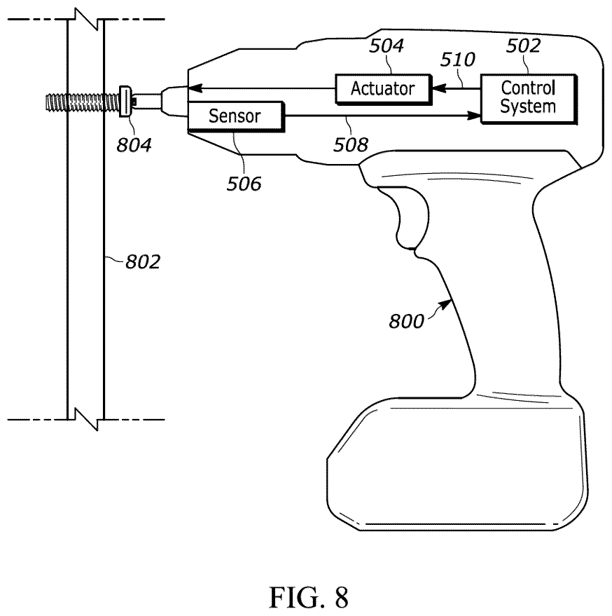

FIG. 8 depicts a schematic diagram of control system 502 configured to control power tool 800, such as a power drill or driver, that has an at least partially autonomous mode. Control system 502 may be configured to control actuator 504, which is configured to control power tool 800. In an example, the control system 502 is configured to control the power tool 800 by executing a diffusion model in accordance with the principles of the present disclosure.

Sensor 506 of power tool 800 may be an optical sensor configured to capture one or more properties of work surface 802 and/or fastener 804 being driven into work surface 802. Classifier 514 may be configured to determine a state of work surface 802 and/or fastener 804 relative to work surface 802 from one or more of the captured properties. The state may be fastener 804 being flush with work surface 802. The state may alternatively be hardness of work surface 802. Actuator 504 may be configured to control power tool 800 such that the driving function of power tool 800 is adjusted depending on the determined state of fastener 804 relative to work surface 802 or one or more captured properties of work surface 802. For example, actuator 504 may discontinue the driving function if the state of fastener 804 is flush relative to work surface 802. As another non-limiting example, actuator 504 may apply additional or less torque depending on the hardness of work surface 802.

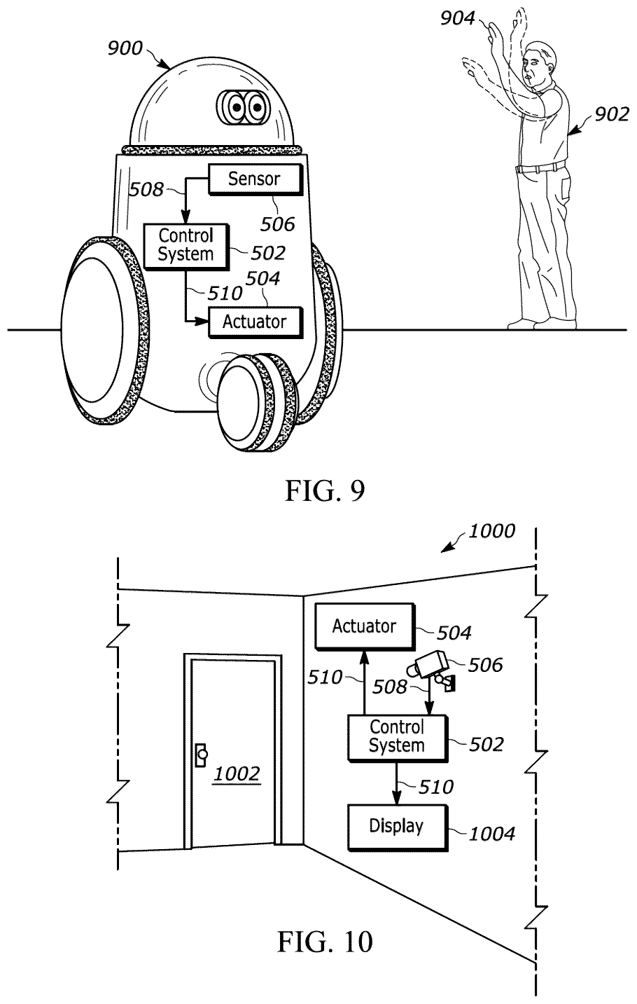

FIG. 9 depicts a schematic diagram of control system 502 configured to control an automated personal assistant 900 (e.g., a robot). Control system 502 may be configured to control actuator 504, which is configured to control automated personal assistant 900. Automated personal assistant 900 may be configured to control a domestic appliance, such as a washing machine, a stove, an oven, a microwave or a dishwasher. In an example, the control system 502 is configured to control the automated personal assistant 900 by executing a diffusion model in accordance with the principles of the present disclosure.

Sensor 506 may be an optical sensor and/or an audio sensor. The optical sensor may be configured to receive video images of gestures 904 of user 902. The audio sensor may be configured to receive a voice command of user 902.

Control system 502 of automated personal assistant 900 may be configured to determine actuator control commands 510 configured to control system 502. Control system 502 may be configured to determine actuator control commands 510 in accordance with sensor signals 508 of sensor 506. Automated personal assistant 900 is configured to transmit sensor signals 508 to control system 502. Classifier 514 of control system 502 may be configured to execute a gesture recognition algorithm to identify gesture 904 made by user 902, to determine actuator control commands 510, and to transmit the actuator control commands 510 to actuator 504. Classifier 514 may be configured to retrieve information from non-volatile storage in response to gesture 904 and to output the retrieved information in a form suitable for reception by user 902.

FIG. 10 depicts a schematic diagram of control system 502 configured to control monitoring system 1000. Monitoring system 1000 may be configured to physically control access through door 1002. Sensor 506 may be configured to detect a scene that is relevant in deciding whether access is granted. Sensor 506 may be an optical sensor configured to generate and transmit image and/or video data. Such data may be used by control system 502 to detect a person's face. In an example, the control system 502 is configured to control the monitoring system 1000 by executing a diffusion model in accordance with the principles of the present disclosure.

Classifier 514 of control system 502 of monitoring system 1000 may be configured to interpret the image and/or video data by matching identities of known people stored in non-volatile storage 516, thereby determining an identity of a person. Classifier 514 may be configured to generate and an actuator control command 510 in response to the interpretation of the image and/or video data. Control system 502 is configured to transmit the actuator control command 510 to actuator 504. In this embodiment, actuator 504 may be configured to lock or unlock door 1002 in response to the actuator control command 510. In some embodiments, a non-physical, logical access control is also possible.

Monitoring system 1000 may also be a surveillance system. In such an embodiment, sensor 506 may be an optical sensor configured to detect a scene that is under surveillance and control system 502 is configured to control display 1004. Classifier 514 is configured to determine a classification of a scene, e.g. whether the scene detected by sensor 506 is suspicious. Control system 502 is configured to transmit an actuator control command 510 to display 1004 in response to the classification. Display 1004 may be configured to adjust the displayed content in response to the actuator control command 510. For instance, display 1004 may highlight an object that is deemed suspicious by classifier 514. Utilizing an embodiment of the system disclosed, the surveillance system may predict objects at certain times in the future showing up.

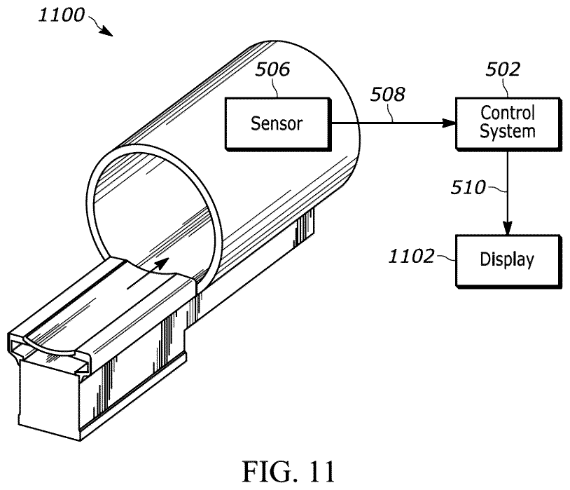

FIG. 11 depicts a schematic diagram of control system 502 configured to control imaging system 1100, for example an MRI apparatus, x-ray imaging apparatus or ultrasonic apparatus. In an example, the control system 502 is configured to control the imaging system 1100 by executing a diffusion model in accordance with the principles of the present disclosure. Sensor 506 may, for example, be an imaging sensor. Classifier 514 may be configured to determine a classification of all or part of the sensed image. Classifier 514 may be configured to determine or select an actuator control command 510 in response to the classification obtained by the trained neural network. For example, classifier 514 may interpret a region of a sensed image to be potentially anomalous. In this case, actuator control command 510 may be determined or selected to cause display 1102 to display the imaging and highlighting the potentially anomalous region.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method of generating a predicted signal using a diffusion model, the method comprising, at one or more processing devices:
receiving an input signal at an encoder model that includes a plurality of intermediate layers and a final layer, wherein the input signal includes at least one of time series data and image data;
generating, via execution of the encoder model, a semantic representation of the input signal, wherein the semantic representation includes an output of at least one of the plurality of intermediate layers;
receiving, at the diffusion model, the semantic representation of the input signal; and
generating and outputting the predicted signal on the semantic representation of the input signal, wherein generating the predicted signal includes at least one of noising and denoising the input signal based on the semantic representation of the input signal, and wherein the predicted signal includes a predicted value indicating the at least one of the time series data and the image data of the input signal.

2. The method of claim 1, further comprising controlling a machine based on the predicted signal generated by the diffusion model.

3. The method of claim 1, further comprising receiving, at the encoder model, information that is based on a current stage of the diffusion model and generating the semantic representation based on the information.

4. The method of claim 1, wherein generating the semantic representation includes generating the semantic representation using a semantic aggregator.

5. The method of claim 4, further comprising receiving, at the semantic aggregator, information that is based on a current stage of the diffusion model.

6. The method of claim 5, wherein generating the semantic representation includes assigning weights to outputs of the plurality of intermediate layers and generating an aggregated semantic representation based on the assigned weights.

7. The method of claim 6, wherein the weights are assigned based on the current stage of the diffusion model.

8. The method of claim 7, wherein the weights correspond to an amount of noise that is being added to or removed in the current stage of the diffusion model.

9. A computing device configured to implement a diffusion model to generate a predicted signal, the computing device including a processing device configured to execute instructions stored in memory to:
receive in input signal at an encoder model that includes a plurality of intermediate layers and a final layer, wherein the input signal includes at least one of time series data and image date;
generate, via execution of the encoder model, a semantic representation of the input signal, wherein the semantic representation includes an output of at least one of the plurality of intermediate layers;
receive, at the diffusion model, the semantic representation of the input signal; and
generate and output the predicted signal based on the semantic representation of the input signal, wherein generating the predicted signal includes at least one of noising and denoising the input signal based on the semantic representation of the input signal, and wherein the predicted signal includes a predicted value indicating the at least one of the time series data and the image data of the input signal.

10. The computing device of claim 9, wherein the computing device is configured to control a machine based on the predicted signal generated by the diffusion model.

11. The computing device of claim 9, wherein the encoder model receives information that is based on a current stage of the diffusion model and generates the semantic representation based on the information.

12. The computing device of claim 9, wherein generating the semantic representation includes generating the semantic representation using a semantic aggregator.

13. The computing device of claim 12, wherein the semantic aggregator receives information that is based on a current stage of the diffusion model.

14. The computing device of claim 13, wherein generating the semantic representation includes assigning weights to outputs of the plurality of intermediate layers and generating an aggregated semantic representation based on the assigned weights.

15. The computing device of claim 14, wherein the weights are assigned based on the current stage of the diffusion model.

16. The computing device of claim 15, wherein the weights correspond to an amount of noise that is being added to or removed in the current stage of the diffusion model.

17. A computer-controlled machine configured to operate in accordance with a predicted signal generated by a diffusion model, the computer-controlled machine comprising:
at least one sensor configured to generate an input signal, wherein the input signal corresponds to at least one of (i) time series data and (ii) an input image;
a control system configured to perform data pre-selection for an object detection system, the control system configured to
receive an input signal at an encoder model that includes a plurality of intermediate layers and a final layer, an input signal, wherein the input signal includes at least one of time series data and image data,
generate, via execution of the encoder model, a semantic representation of the input signal, wherein the semantic representation includes an output of at least one of the plurality of intermediate layers,
receive, at the diffusion model, the semantic representation of the input signal, and
generate and output the predicted signal based on the semantic representation of the input signal, wherein generating the predicted signal includes at least one of noising and denoising the input signal based on the semantic representation of the input signal, and wherein the predicted signal includes a predicted value indicating the at least one of the time series data and the image data of the input signal; and
an actuator configured to control an operation of the computer-controlled machine based on the predicted signal.

18. The computer-controlled machine of claim 17, wherein the encoder model is configured to generate the semantic representation using information that is based on a current stage of the diffusion model, and wherein generating the semantic representation includes generating the semantic representation using a semantic aggregator.

19. The computer-controlled machine of claim 18, wherein generating the semantic representation includes assigning weights to outputs of the plurality of intermediate layers and generating an aggregated semantic representation based on the assigned weights, wherein the weights are assigned based on the current stage of the diffusion model, and wherein the weights correspond to an amount of noise that is being added to or removed in the current stage of the diffusion model.

20. The computer-controlled machine of claim 17 corresponding to one of a vehicle, a robot, a tool, a manufacturing machine, a monitoring system, and an image system.
